(19) United States
(12) Patent Application Publication
(10) Pub. No.: US 2015/0319147 A1
(43) Pub. Date: Nov. 5, 2015

(54) SYSTEM AND METHOD FOR FILE ENCRYPTING AND DECRYPTING

(71) Applicant: Sunix Co., LTD, New Taipei City (TW)

(72) Inventors: Ming-Cheng Lin, New Taipei City (TW); Po-Sheng Wang, New Taipei City (TW)

(73) Assignee: Sunix Co., LTD, New Taipei City (TW)

(21) Appl. No.: 14/266,921

(22) Filed: May 1, 2014

(51) Int. Cl. H04L 29/06; G06F 21/62

(52) U.S. Cl. CPC H04L 63/0457; G06F 21/6218; H04L 63/083

(57) ABSTRACT

A system and method of file encrypting/decrypting is disclosed. The system comprises an external device and a host comprising a communication port, a processor, a storage module and an agent module. The processor connects to the communication port and the storage module. The communication port connects to the external device. The storage module stores an operation system, and is configured to have an encryption partition, in which a plurality of encrypted files is stored. The processor executes the operation system and the agent module. The agent module verifies the identification information in order to determine whether to mount the encryption partition. When the encryption partition is mounted into the operation system, the agent module encrypts the plaintext file stored in the encryption partition as an encrypted file, or accesses an encrypted file from the encryption partition. The agent module decrypts the encrypted file and outputs a corresponding plaintext file.

### BACKGROUND

1. Technical Field

The disclosure is related to a system and a method for file encrypting and decrypting, and in particular to a processing system and processing method for file encrypting and decrypting.

2. Related Art

Popularity of computers leads to rapid transmission of information. As there is not protection for the file access by the users, interested parties can obtain files through improper means. Passwords or encryption may increase safety for file access. However, additional selection or other process is required for file access. Such operation is additional burden to the users. The length of the password also affects user habits. Too much or too long password length bring inconvenience for user memory.

Although the files may be protected by the afore-mentioned method, devices for storing the files do not have corresponding protection. Thus interested parties may obtain the files from the storage devices by illegal means. For example, the hard disk is removes from the target computer and then is installed to another computer. Thus the storage devices also require protection.

### SUMMARY

The disclosure discloses a processing system for file encrypting and decrypting to encrypting files or decrypting files during file access.

The processing system comprises an external device and a host. The external device stores identification information. The host comprises a communication port, a processor, a storage module and an agent module. The processor connects to the communication port and the storage module. The communication port connects to the external device. The storage module stores an operation system. The storage module is configured to have an encryption partition. A plurality of encrypted files is stored in the encryption partition. The processor executes the operation system and the agent module. The agent module verifies the identification information to mount the encryption partition. When the encryption partition is loaded into the operation system, the agent module encrypts the plaintext file stored in the encryption partition as an encrypted file, or accesses an encrypted file from the encryption partition. The agent module decrypts the encrypted file and outputs a corresponding plaintext file.

The disclosure further discloses a processing method for file encrypting and decrypting to encrypt files or decrypt files during file access.

The processing method for file encrypting and decrypting comprises connecting an external device to a host; when the agent module in the host verifies the identification information of the external device, loading, by an operation system in the host, an encryption partition; encrypting, by the agent module, a plaintext file in the encryption partition as an encrypted file; accessing an encrypted file from the encryption partition and decrypting, by the agent module, the encrypted file and outputting a plaintext file.

The disclosure further discloses a processing method for file encrypting and decrypting to encrypting files or decrypting files during file access.

The processing method for file encrypting and decrypting comprises connecting an external device to a host; verifying the agent module in the host to confirm the validity of the identification information of the external device; when the identification information is invalid or the external device does not connect to the host, prohibiting, by the agent module, the encrypted files in the encrypted folder from being accessed; when the identification information is valid, determining the access type of the encrypted folder; when the plaintext file is written into the encrypted folder, encrypting, by the agent module, the plaintext files and outputting the corresponding encrypted file; when the encrypted file is accessed from the encrypted folder, decrypting, by the agent module, the encrypted file and outputting the corresponding plaintext file.

The processing system and method for file encrypting and decrypting of the disclosure provides corresponding encryption and decryption for files during file access. The encryption and decryption process by the host is further determined according to the validity of the external device. Therefore, the file is only accessed when connection between the external device and the host is valid.

For a fuller understanding of the nature and objects of the invention, reference should be made to the following detailed description taken in connection with the accompanying drawings.

### BRIEF DESCRIPTION OF THE DRAWINGS

Other objects, advantages, and novel features of the present invention will become more apparent from the following detailed description when taken in conjunction with the accompanying drawings, and wherein:

FIG. 1 illustrates the architecture of the disclosure;

FIG. 2 illustrates the installment process of the disclosure;

FIG. 3 illustrates the operation process of the disclosure;

FIG. 4A illustrates the operation process of the operation command of the disclosure;

FIG. 4B illustrates the incorporation of the identification feature of the disclosure;

FIG. 5 illustrates the operation process for the protection method for a remote disk of the disclosure;

FIG. 6 illustrates another architecture of the disclosure;

FIG. 7 illustrates another operation process of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

The detailed characteristics and advantages of the disclosure are described in the following embodiments in details, the techniques of the disclosure can be easily understood and embodied by a person of average skill in the art, and the related objects and advantages of the disclosure can be easily understood by a person of average skill in the art by referring to the contents, the claims and the accompanying drawings disclosed in the specifications.

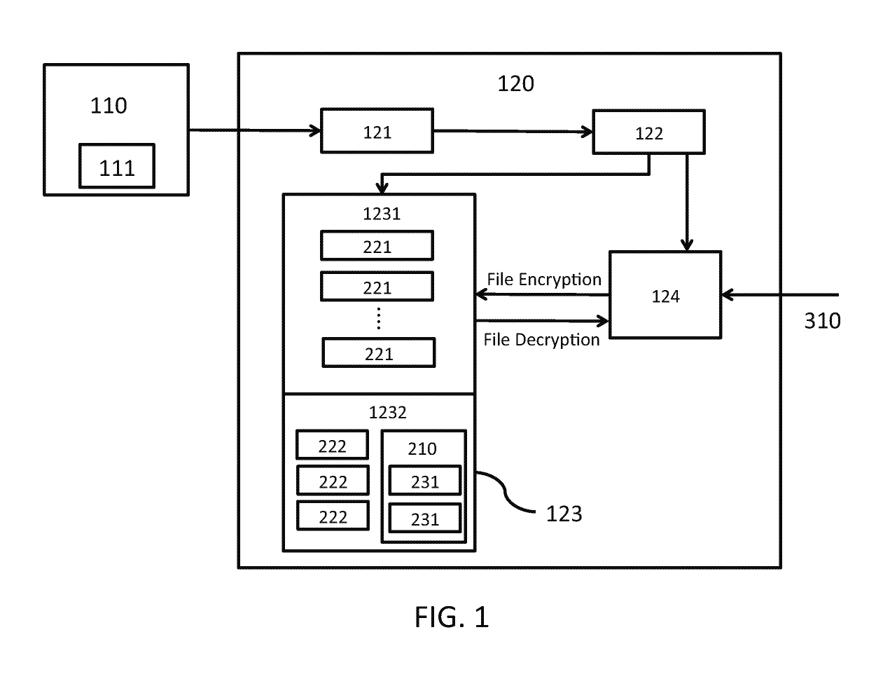

FIG. 1 illustrates the architecture of the disclosure. The process system for file encrypting and decrypting of the disclosure comprises an external device 110 and a host 120. The host 120 comprises a communication port 121, a processor 122, a storage module 123 and an agent module 124. The external device 110 connects to the host 120 through the communication port 121. The communication port 121 may be a wire interface (IEEE 802.3x) or a wireless interface (IEEE 802.1x). The wire interface may be, but not limited to, Universal Serial Bus (USB), Fire wire (or IEEE 1394), or Serial Advanced Technology Attachment (SATA). The wireless interface may be, but not limited to, Bluetooth, Wi-Fi, ZigBee, Radio Frequency Identification (RFID) or Near Field Communication (NFC).

The external device 110 stores identification information 111. The identification information 111 may by set up by the manufacture, or by the user. The user may set up the identification information 111 when the agent module 124 is installed.

The host 120 may be but not limited to a PC, a laptop or a server. The disclosure may be applied to a portable electronic device, like Personal Digital Assistant, mobile phones or tablets. The personal computer is adopted for the illustration. Persons skilled in the related art may implement the system or method of the disclosure to other electronic devices according to the disclosure.

The processor 122 electrically connects to the communication port 121, and the storage module 123. The connecting interface of the external device 110 corresponds to the type of the communication port 121. The processor 122 may receive the identification information 111 stored in the external device 110 through the communication port 121. The agent module 124 may be implemented by software or hardware. The implementation by software is illustrated as below. The agent module 124 may be embedded in the operation system 210 and executed when the operation system 210 is activated. The implementation by hardware is illustrated as below. The agent module 124 can be an adapter card of the host 120 or embedded in the specific memory such that the operation system 210 may execute the agent module 124 according to the location in the disk when the operation system 210 is activated.

At least one encryption partition 1231 is defined in the storage module 123. The disk space except the encryption partition 1231 is defined as a normal partition 1232. In general, the agent module 124 may manage the partition of the disk space though a partition management process. The operation system 210 is stored in the normal partition 1232. The encryption partition 1231 stores an encryption file 221. In the disclosure, the files that are not encrypted are referred as plaintext files 222, while the files that are encrypted are referred as encrypted files 221.

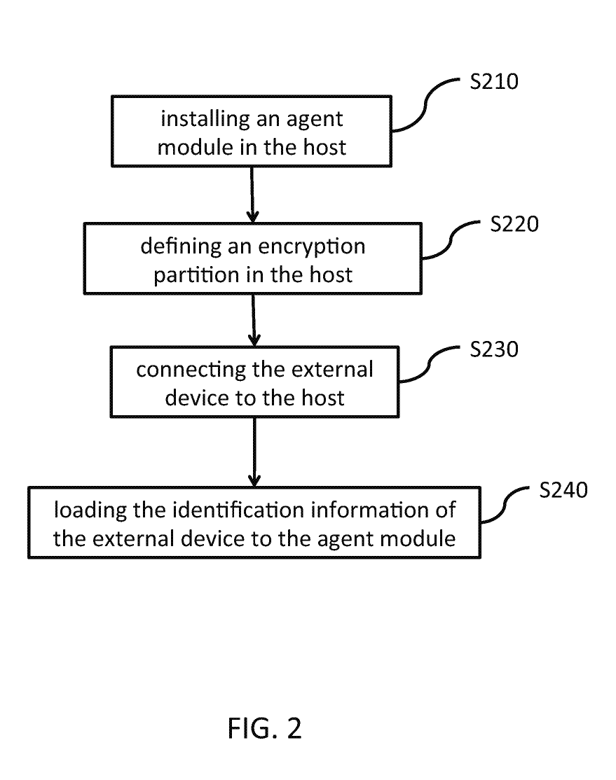

Two processes are described in the following context to clearly illustrate the installment and the operation. FIG. 2 illustrates the installment process of the disclosure. The installment process of the disclosure comprises the following steps:

Step S210: installing an agent module in the host;

Step S220: by the agent module, defining an encryption partition in the host;

Step S230: connecting the external device to the host by the user; and

Step S240: by the agent module, loading the identification information of the external device to the agent module.

First, the agent module 124 is installed into the host 120. The agent module 124 selects a current partition or a new partition as the encryption partition 1231 according to the user's selection or the system default option. Then the agent module 124 requests to the user to connect the external device 110 to the host 120. The connection may be physical or wireless as set forth. When the external device 110 is connected to the host for the first time, the agent module 124 records the identification information 111 of the external host 110 to verify weather the external device 110 is recorded in the host 120 or not. After the process set forth is completed, the agent module 124 determines a visible attribute of the encryption partition 1231 according to the connection between the external device 110 and the host 120. When the external device 110 disconnects with the host, the agent module 124 hides the encryption partition 1231.

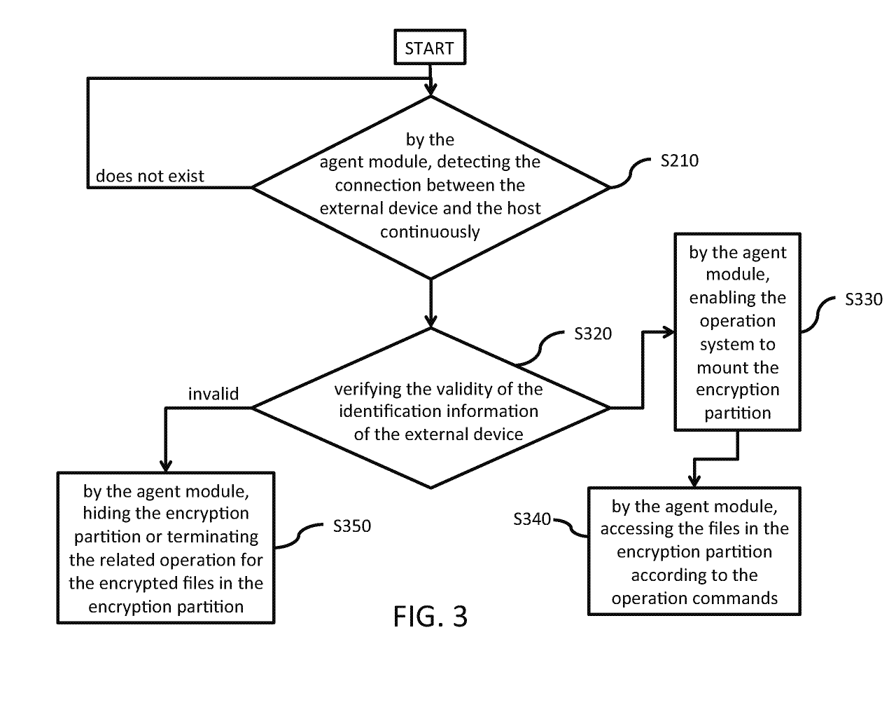

After the installment process is completed, refer to FIG. 3 illustrating the operation process of the disclosure. The encrypting and decrypting process of the disclosure comprises the following steps:

Step S310: by the agent module, detecting the connection between the external device and the host continuously;

Step S320: by the agent module, verifying the validity of the identification information of the external device when the external device connects to the host;

Step S330: by the agent module, enabling the operation system to mount the encryption partition when the identification information is valid;

Step S340: by the agent module, accessing the files in the encryption partition according to the operation commands; and

Step S350: by the agent module, hiding the encryption partition or terminating the related operation for the encrypted files in the encryption partition when the external device does not connect to the host for the identification information is invalid.

First, the user connects the external device 110 to the host 120. The agent module 124 receives the operation commands 310 sent by the user in addition to the verification of the validity of identification information of the external device 110. As the illustration set forth, the agent module 124 records corresponding external device 110. Therefore, the external device 110 that are not recorded in the agent module 124 is defined as being invalid, while the external device 110 that are recorded in the agent module 124 is defined as being valid. The agent module 124 does not dissolve the hidden state of the encryption partition 1231.

When the external device 110 is valid, the state of the encryption partition 1231 is changed from the hidden state to the visible state by the agent module 124. Thus, the user may see the encryption partition 1231 from the operation system 210. The agent module 124 continues detecting the connection between the external device 110 and the host 120. When the user removes the external device 110 from the host, the agent module 124 unloads the encryption partition 1231 and terminates related operations for the encrypted files 221. Or when an invalid external device 110 connects to the host 124, the agent module 124 does not perform any process for the hidden encryption partition 1231.

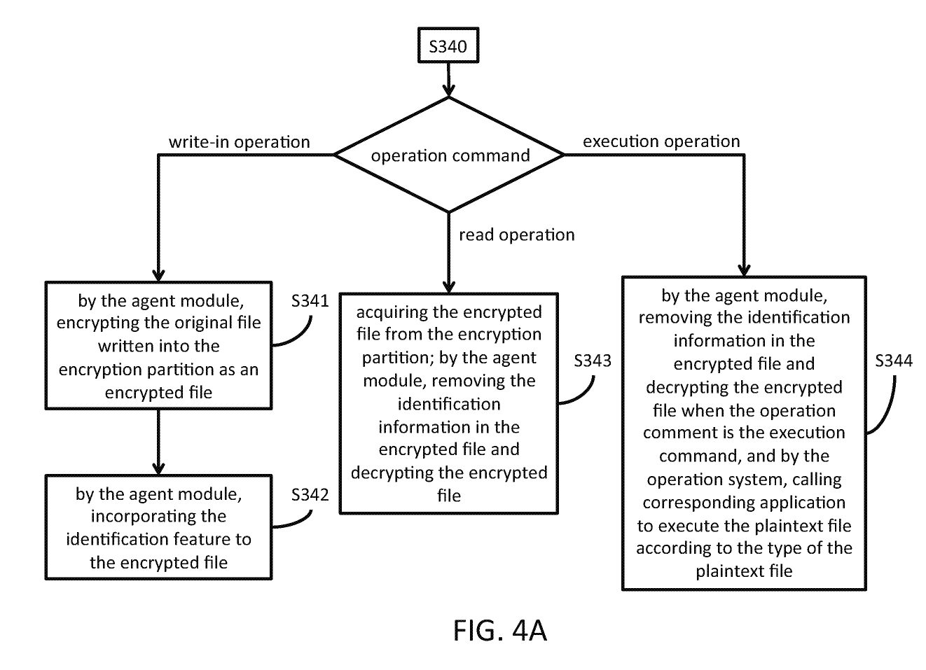

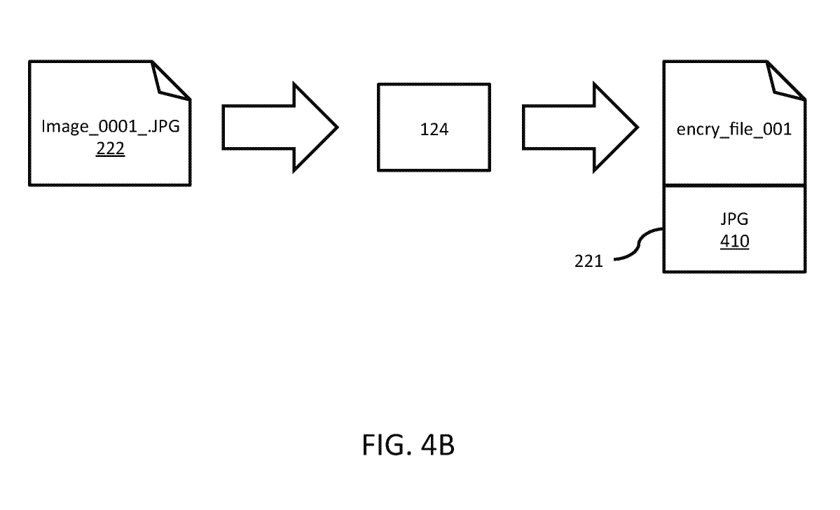

The disclosure further discloses the protection for the operation commands 310 for the encrypted files 221 as follows. The operation commands 310 may be a write-in command, a read-out command, an execution command, or a deletion command. Refer to FIG. 4A illustrating the operation process of the operation command of the disclosure, comprising the following steps:

Step S341: by the agent module, encrypting the plaintext file written into the encryption partition as an encrypted file when the operation command is the write-in command;

Step S342: by the agent module, incorporating the identification feature to the encrypted file;

Step S343: acquiring the encrypted file from the encryption partition when the operation command is the read-out operation; by the agent module, removing the identification information in the encrypted file and decrypting the encrypted file; and

Step S344: by the agent module, removing the identification information in the encrypted file and decrypting the encrypted file when the operation comment is the execution command, and by the operation system, calling corresponding application to execute the plaintext file according to the type of the plaintext file.

Refer to FIG. 4B illustrating the incorporation of the identification feature of the disclosure. When the write-in operation is executed, the agent module 124 encrypts the plaintext file 222 and outputs an encrypted file 221. For example, the agent module 124 encrypts the plaintext file 222 named “Image_{—}0001_.JPG” and outputs an encrypted file 221 named “encry_file_{—}001”. Then the agent module 124 incorporates identification feature 410 to the encrypted file 221. The file information in the plaintext file 222 is masked after encryption process. Therefore, the disclosure incorporates the identification feature 410 into the encrypted file 221 such that the user may select corresponding encrypted file 221 from the file selection menu. The identification feature 410 may be incorporated into either the file name of the encrypted file 221 or the encrypted file 221.

The type of encryption/decryption process may be, but not limited to, Triple Data Encryption Standard (Triple DES), Blowfish, IDEA, RC4, RC5, RC6, RSA, ECC, Diffie-Hellman, El Gamal, or Advanced Encryption Standard (AES). In general, the agent module 124 may performs corresponding encryption/decryption process according to the computing capability of the host 120.

Continuing the example set forth, the agent module adds the filename extension “.jpg” to the encrypted file 221 named “encry_file_{—}001”. Therefore, after the encryption process set forth and incorporation of the identification feature 410, the file name of the encrypted file 221 becomes as “encry_file_{—}001.jpg”. Or the agent module may incorporate the identification feature 410 into the head of the encrypted file 221 named “encry_file_{—}001”.

Besides the write-in operation, the disclosure also discloses corresponding process for the read-out operation. When the agent module 124 receives a command for accessing the encrypted file 221, the agent module 124 removes the identification feature 410 in the encrypted file 221. Then the agent module 124 decrypts the encrypted file 221 without the identification feature 410. Continuing the example set forth, the agent module 124 removes “.jpg” of the identification information in the encrypted file 221 named “encry_file_{—}001 jpg”. Then the agent module 124 decrypts the encrypted file 221 named “encry_file_{—}001” and outputs the plaintext file 222 named “Image_{—}0001_.JPG”.

Further, when the agent module 124 receives the operation command 310 for the encrypted file 221, the agent module 124 performs the following process on the encrypted file 221. The agent module 124 removes the identification information for the selected encrypted file 221 and decrypts the file. Then, the operation system 210 calls the corresponding application 231 according to the type of the plaintext file 222, and the application 231 opens the plaintext file 222. The example set forth is still used for explanation. We suppose that the user selects the encrypted file 221 named “encry_file_{—}001.jpg” from the encryption partition 1231. The agent module 124 removes the identification feature 410 for the encrypted file 221 and decrypts the file, and then outputs the plaintext file 222 named “Image_{—}0001_.JPG”. Then the agent module sends a request to open “Image_{—}0001_.JPG”. The operation system 210 calls the corresponding application 231 according to the plaintext file 222. In this example, the plaintext file 222 is an image file. Therefore, the operation system 210 may call corresponding image software to open the file for further processing.

When the external device 110 disconnects with the host 120 during the period of opening the plaintext file 222, the agent module encrypts the current processed plaintext file 222. The agent module then stores the encrypted file 221 back to the encryption partition 1231. After the encrypted file 221 is stored, the agent module sets the state of the encryption partition 1231 as being hidden.

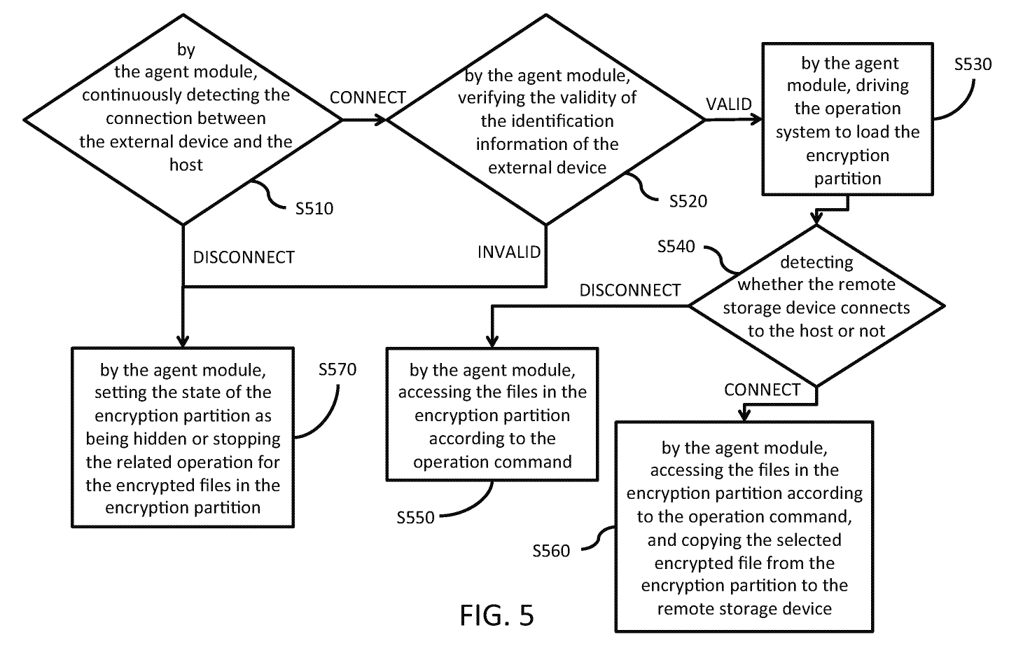

The present disclosure may be applied in the host 120 or in a remote storage device. The remote storage device may connect to the host 120 through network. As the remote storage device connects with the host 120 continuously through the network, the disclosure further discloses a protection method for the remote storage device. Refer to FIG. 5 illustrating the operation process for the protection method for a remote disk of the disclosure.

Step S510: by the agent module, continuously detecting the connection between the external device and the host;

Step S520: by the agent module, verifying the validity of the identification information of the external device when the external device connects to the host;

Step S530: by the agent module, driving the operation system to load the encryption partition when the identification information is valid;

Step S540: detecting whether the remote storage device connects to the host or not;

Step S550: by the agent module, accessing the files in the encryption partition according to the operation command when the remote storage device does not connect to the host;

Step S560: by the agent module, accessing the files in the encryption partition according to the operation command when the remote storage device connects to the host, and copying the selected encrypted file from the encryption partition to the remote storage device; and

Step S570: by the agent module, setting the state of the encryption partition as being hidden when the external device disconnects with the host or the identification information is invalid, or stopping the related operation for the encrypted files in the encryption partition.

In this embodiment, the agent module 124 further detects whether the remote storage device 610 connects to the host 120. When the remote storage device 610 disconnects with the host 120, the agent module 124 processes the plaintext file 222 according to the method set forth and then stores the file in the encryption partition. When the hard disk 610 connects to the host 120, the agent module 124 executes the related operation command 310 as set forth according to the encrypted file 221 selected by the user from the encryption partition 1231, and copies the encrypted file 221 that has been processed to the remote storage device 610. If disconnection occurs to the remote storage device 610 during operation, the host 120 stores the encrypted file 221 in the encryption partition 1231.

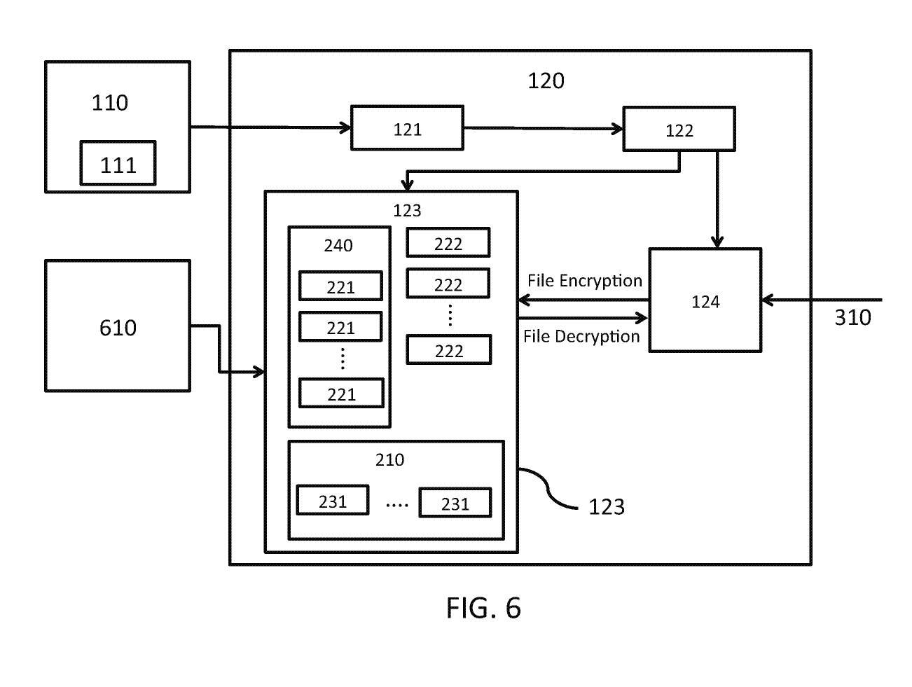

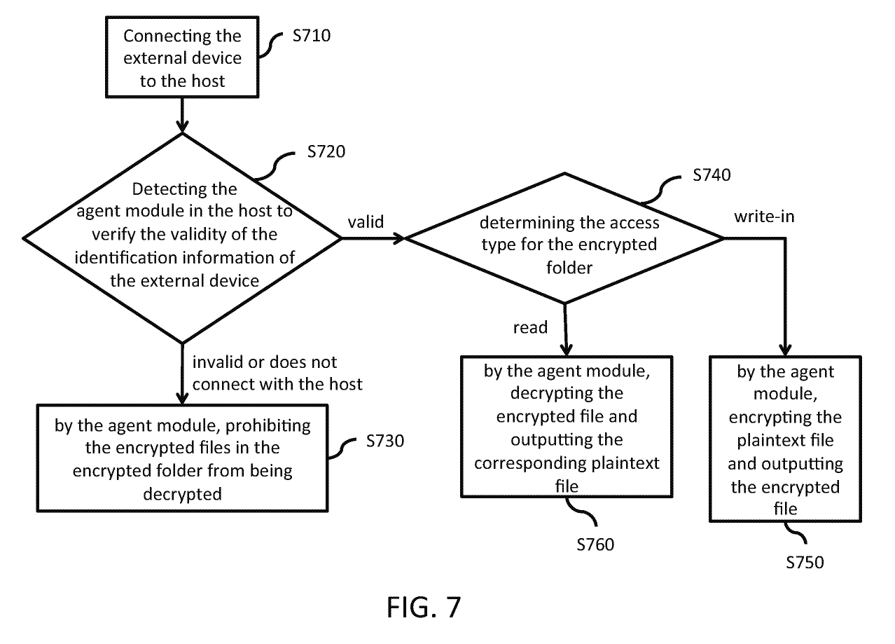

Besides the embodiments set forth, the disclosure may also be applied for encrypted folders. FIG. 6 illustrates another architecture of the disclosure. FIG. 7 illustrates another operation process of the disclosure. This embodiment comprises an external device 110 and the host 120. The host 120 comprises a communication port 121, a processor 122, a storage module 123, and an agent 124. The processor 122 electrically connects to the communication port 121, the storage module 123 and the agent module 124. In this embodiment, the storage unit 123 stores plaintext files 222, encrypted files 221 and encrypted folders 240. In this embodiment, the folder having encrypted files 221 stored therein is defined as an encrypted folder 240. The related operation for the encrypted folder 240 and the encrypted files 221 comprises the following steps:

Step S710: Connecting the external device to the host;

Step S720: Detecting the agent module in the host to verify the validity of the identification information of the external device;

Step S730: When the identification information is not valid or the external device does not connect to the host, by the agent module, prohibiting the encrypted files in the encrypted folder from being decrypted;

Step S740: When the identification information is valid, determining the access type for the encrypted folder;

Step S750: When the plaintext file is written into the encrypted folder, by the agent module, encrypting the plaintext file and outputting the encrypted file; and

Step S760: When the encrypted file is accessed from the encrypted file, by the agent module, decrypting the encrypted file and outputting the corresponding plaintext file.

First, the external device 110 is connected to the host 120. The agent module 124 verifies weather the identification information 111 of the external device 124 is valid. When the identification information 111 is valid, the agent module 124 continuously monitors whether the user accesses the encrypted folder 240 storing the encrypted files 221. When the user accesses the encrypted folder 240 storing the encrypted files 221, the agent module 124 monitors the access type through the operation system 210. The agent module 124 determines whether the plaintext file is stored in the encrypted folder 240, or the encrypted file 221 is accessed from the encrypted folder 240.

When the plaintext file 222 is written into the encrypted folder 240, the agent module 124 encrypts the plaintext file 222 and outputs the encrypted file 221 to the encrypted folder 240. When the user intends to access any of the encrypted files 221 from the encrypted folder 240, the agent module 124 encrypts the selected encrypted file 221 and outputs corresponding plaintext file 222. The corresponding plaintext file 222 is stored into the location selected by the user. If the user intends to execute the encrypted file 221 in the encrypted folder, the agent module 124 encrypts the selected encrypted file 221. The operation system 210 calls corresponding application 231 to open the encrypted original file.

During the file access process, the external device 110 disconnects with the host 120, the agent module 120 completes the current encryption/decryption process. Then the agent module 124 prohibits the encrypted file 221 in the encrypted folder 240 from being accessed by the user. Similarly, when the identification information 111 is invalid, the agent module 124 also prohibits the encrypted file 221 in the encrypted folder 240 from being accessed by the user.

The processing system and method for file encrypting and decrypting provides corresponding encrypting or decrypting process during file access. The host 120 determines whether to enable the encrypting or decrypting process according to the validity of the external device 110. Therefore, the user is allowed to access the file only when the valid external device 110 connects to the host 120.

Although the invention has been explained in relation to its preferred embodiment, it is not used to limit the invention. It is to be understood that many other possible modifications and variations can be made by those skilled in the art without departing from the spirit and scope of the invention as hereinafter claimed.

What is claimed is:

1. A processing system for file encrypting/decrypting, comprising:
an external device storing identification information; and
a host comprising a communication port, a processor, a storage module and an agent module, wherein the processor connects with the communication port and the storage module, the communication port connects to the external device, and the storage module stores an operation; the storage module has an encryption partition for storing a plurality of encrypted files; the processor executing the operation system and the agent module;
wherein the agent module determines whether to load the encryption partition after verifying the identification information; when the operation system mounts the encryption partition, the agent module encrypts a plaintext file written in the encryption partition as the encrypted file, or the agent module accesses any of the encrypted files from the encryption partition, and decrypts the encrypted file and outputs the plaintext file.

2. The processing system for file encrypting/decrypting of claim 1, wherein the storage module defines a normal partition except the encryption partition, wherein the normal partition stores the operation system and the plaintext files.

3. The processing system for file encrypting/decrypting of claim 1, wherein after the plaintext file is encrypted, the agent module incorporates an identification feature into the encrypted file, and removes the identification feature from the encrypted file before decrypting the encrypted file.

4. The processing system for file encrypting/decrypting of claim 1, wherein the operation system calls a corresponding application according to the type of the plaintext file, and the application executes the plaintext file.

5. The processing system for file encrypting/decrypting of claim 1, further comprising a remote storage device connecting with the host; wherein the agent module copies the selected encrypted file to the remote storage device.

6. A processing method for file encrypting/decrypting to encrypt files or decrypt files during file access, comprising:
connecting an external device to a host;
when an agent module in the host verifies the identification information of the external device, loading, by an operation system in the host, an encryption partition;
encrypting, by the agent module, a plaintext file in the encryption partition as an encrypted file;
accessing the encrypted file from the encryption partition, by the agent module, decrypting the encrypted file and outputting the plaintext file; and
when the host does not verify the identification information correctly, by the agent module, stopping verifying and detecting whether there is another external device connected to the host.

7. The processing method for file encrypting/decrypting of claim 6, wherein after the step of encrypting a plaintext file as an encrypted file further comprises a step of, by the agent module, incorporating an identification feature into the encrypted file.

8. The processing method for file encrypting/decrypting of claim 7, wherein before the step of decrypting the encrypted file as the plaintext file further comprises a step of, by the agent module, removing the identification feature from the encrypted file.

9. The processing method for file encrypting/decrypting of claim 8, wherein when the agent module receives an operation command to the encrypted file, the agent module performs the steps of:
removing the identification information from the encrypted file;
decrypting the encrypted file and outputting the plaintext file;
calling the operation system; and
by the operation system, calling a corresponding application according to the type of the plaintext file to execute the plaintext file.

10. A processing method for file encrypting/decrypting, comprising:
connecting an external device to a host;
detecting the agent module in the host to verify the validity of the identification information of the external device;
when the identification information is not valid or the external device does not connect to the host, by the agent module, prohibiting the encrypted files in the encrypted folder from being decrypted;
when the identification information is valid, determining the access type for the encrypted folder;
when the plaintext file is written into the encrypted folder, by the agent module, encrypting the plaintext file and outputting the encrypted file; and
when the encrypted file is accessed from the encrypted file, by the agent module, decrypting the encrypted file and outputting the corresponding plaintext file.
